(19) United States
(12) Patent Application Publication
(10) Pub. No.: US 2005/0251469 A1
(43) Pub. Date: Nov. 10, 2005

(54) Network topology for processing consumer financial transactions

(76) Inventor: Gopal Nandakumar, San Antonio, TX (US)

Correspondence Address: WAYNE J COLTON INC;THE MILAM BUILDING SUITE 1032, 115 EAST TRAVIS STREET, SAN ANTONIO, TX, 78205, US

(21) Appl. No.: 11/182,146

(22) Filed: Jul. 15, 2005

Related U.S. Application Data
(63) Continuation-in-part of application No. 10/352,695, filed on Jan. 27, 2003.

(51) Int. Cl. G06F 17/60

(52) U.S. Cl. 705/35

(57) ABSTRACT

A network topology for efficient processing of consumer financial transactions includes an intermediary database server adapted for the secure collection and selective conveyance of financial information in facilitation of consumer financial transactions and a purchase gateway for accessing the intermediary database server for the provision by the purchaser of the purchaser's financial account data and for providing in response a unique code; an activation gateway for the subsequent secure collection of said unique code and a beneficiary's identifying information and redemption selection; and a payment gateway for secure conveyance by the intermediary database server to a third party of payment data, the third party being determined according to the beneficiary's identifying information and redemption selection. The identifying information generally takes the form of one of a predetermined set of media and the redemption selection is generally chosen from a predetermined set of choices.

### RELATED APPLICATION

This present application claims priority under 35 U.S.C. § 120 as a continuation-in-part of Applicant's co-pending U.S. patent application Ser. No. 10/352,695 filed Jan. 27, 2003. By this reference, the full disclosure, including the claims and drawings, of U.S. patent application Ser. No. 10/352,695 is incorporated herein as though now set forth in its entirety.

### FIELD OF THE INVENTION

The present invention relates to electronic financial networks. More particularly, the invention relates to a network topology for processing consumer financial transactions specifically including systems and methods for efficient handling of gift and/or promotional transactions and maintenance of consumer personal data.

### BACKGROUND OF THE INVENTION

The use of credit cards originated in the United States in the 1920s with the advent of house cards for making purchases at individual companies, such as hotel chains and oil companies. In the 1950s, though, universal credit cards 10 were introduced, allowing consumers 11 to use their cards 10 at any of a variety of stores and businesses 12. With this convenience came immediate popularity and now the majority of U.S. citizens as well as many citizens of nations around the world have at least one credit card 10 with which they make combined annual purchases well into the trillions of dollars. With such enormous volume of use, it is imperative to the economic efficiency of the credit card system 13 to minimize transaction costs, from the issuance of cards 10 through the maintenance of customer information to the processing of transactions, both conventional and specialized such as, for example, gift purchases.

To better appreciate the efficiencies enabled by the present invention, therefore, it is instructive to first consider the conventional schemes for handling various electronic transactions. As shown in FIG. 1, typical universal credit card usage begins with a potential customer 11 making application to an issuing bank 14 for issuance of a credit card 10. Typically, the potential customer makes his or her application by filling out and mailing or faxing a paper application or providing information though an Internet website or by telephone. In any case, the application includes pertinent information about the potential customer 11, including the potential customer's name, address, income and banking information and other identifying data. For every newly requested card 10, the issuing bank 14 must collect the provided information, which is then utilized by issuing bank 14 to access the potential customer's credit records for assessment of the potential customer's creditworthiness.

If the issuing bank's credit requirements are met, the issuing bank 14 assigns the new customer 11 an amount of available credit and proceeds to issue a credit card 10 to the customer 11. This process, however, requires that for every new account opened, a personalized card 10 must be manufactured and then delivered to the new customer 11—usually by mail. As a result, the issuing bank 14 incurs the expense of producing the new card 10, whether the new customer 11 accepts and uses the new account or not, and the new customer 11 must wait from a few days to a week or more for receipt (and, hence, availability for use) of the new card 10.

Once the new customer 11 receives the newly manufactured, personalized card 10 and decides to make use of it, he or she must generally execute some form of activation process prior to use in order to verify delivery of the new card 10 to the intended recipient. Usually, the activation process involves calling a telephone number or accessing an Internet website and providing information from both the card 10 and the customer's application or using the card 10 in an automated teller machine with a pre-selected or separately mailed personal identification number (“PIN”). While the purpose of the activation process is to reduce instances of fraud, it is often no more difficult for a perpetrator to gain access to the required activation information than it is for him or her to gain access to the new card 10 or information contained thereon. As a result, the delivery of each new card 10 presents financial risk to both the issuing bank 14 and the issuing bank's customer 11.

Once a newly issued credit card is successfully activated, the customer 11 may then present the credit card 10 at a merchant location 12 for use in making a purchase. Upon presentation, the merchant 15 typically transmits a credit authentication request to a credit card processor, called an acquirer 16, by swiping the customer's credit card 10 through, or entering the customer's credit card number and expiration date into, the merchant's credit card processing terminal 17 and entering the transaction amount into the terminal 17. In a much lesser utilized alternative method, typically only resorted to in the absence of a credit card processing terminal 17, the merchant 15 may also telephone the foregoing information to the acquirer 16. In any case, the acquirer 16 accesses the relevant credit card network 18 to check the transaction for validity and to determine whether the customer 11 has sufficient credit available to complete the transaction. To this end, the credit card network servers 18 utilize the identifying information from the customer's credit card 10 to identify the issuing bank 14 and then routes the credit authentication request to the issuing bank 14 for approval. If sufficient credit is available, the issuing bank 14 places a temporary hold on the requested funds and transmits an approval message back through the credit card network 18 to the acquirer 16, which then transmits a payment guarantee back to the requesting merchant through the merchant's credit card processing terminal 17 (or, for telephone authorization, by giving an authorization confirmation number before terminating the telephone call). The merchant 15 then generates a transaction receipt for the customer 11, either automatically through the credit card processing terminal 17 or by handwritten document.

At the conclusion of a business period, the merchant 15 requests its acquirer 16 to initiate settlement by transmitting a message through the merchant's credit card processing terminal 17 to the acquirer's server 16 (or, as before, but for purposes of preserving clarity not further herein discussed, by telephone). The acquirer 16 in turn then accesses the credit card network 18 to initiate the settlement process. According to the typical procedure, the credit card network servers 18 communicate with the issuing bank's computers 14 to request electronic transfer of funds 19 from the issuing bank 14 to the merchant's bank, called the acquiring bank 20. In response to the request, the issuing bank 14 electronically transfers the requested funds 19 to the acquiring bank 20, to be deposited therein in the merchant's account.

Following settlement, the issuing bank 14 notes the customer's account for billing according to the terms of the credit card account and simultaneously notes a reduction in the amount of available credit retained by the customer 11. The issuing bank 14 bills the customer and, after payment of the bill by the customer 11, the issuing bank 14 notes an increase in the amount of available credit retained by the customer 11.

As is apparent from the foregoing discussing, the process of issuing and maintaining a credit card account involves many steps, including the collection of significant amounts of information and the generation of personalized media. Although not discussed in detail, it is noted that the generation and accounting for merchant gift cards, merchant purchasing club cards and the like also involve many of the same, often rather expensive steps, but generally without many of the financial incentives accorded to credit card associations. It is therefore an overriding object of the present invention to improve over the prior art by providing a network topology 21 that facilitates information sharing in support of consumer financial transactions. Additionally, it is an object of the present invention to provide such a network topology 21 that eliminates much of the costs associated with the maintenance of consumer loyalty and gift programs, particularly including the costs of preparing and distributing “cards.” Finally, it is an object of the present invention to provide such a network topology 21 that may also be utilized for the dissemination of information pertaining to product promotions and processing of transactions involving such product promotions as well as may be utilized for streamlining various consumer transactions such as, for example, placing of takeout orders and/or hotel and restaurant reservations.

### SUMMARY OF THE INVENTION

In accordance with the foregoing objects, the present invention—a network topology for efficient processing of consumer financial transactions—generally comprises an intermediary database server adapted for the secure collection and selective conveyance of financial information in facilitation of consumer financial transactions and a purchase gateway for accessing the intermediary database server for the provision by the purchaser of the purchaser's financial account data and for providing in response a unique code; an activation gateway for the subsequent secure collection of said unique code and a beneficiary's identifying information and redemption selection; and a payment gateway for secure conveyance by the intermediary database server to a third party of payment data, the third party being determined according to the beneficiary's identifying information and redemption selection. The identifying information generally takes the form of one of a predetermined set of media and the redemption selection is generally chosen from a predetermined set of choices.

The financial information may be the credit purchaser's financial account data and a transaction amount. A hospitality gateway may be provided for automating, through utilization of the infrastructure of the network topology, various consumer transactions made on a regular basis by the beneficiary.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a functional block diagram, a typical credit card association processing network;

FIG. 2 shows, in a functional block diagram, the preferred embodiment of the network topology of the present invention;

FIG. 3 shows, in a flowchart, an overview of the operation of the principle method of the present invention;

FIG. 4 shows, in a flowchart, details of the gift purchase process of the present invention;

FIG. 5 shows, in a flowchart, details of the gift activation process of the present invention, including transmission of payment information to an appropriate recipient; and

FIG. 6 shows, in a flowchart, details of the gift redemption process of the present invention.

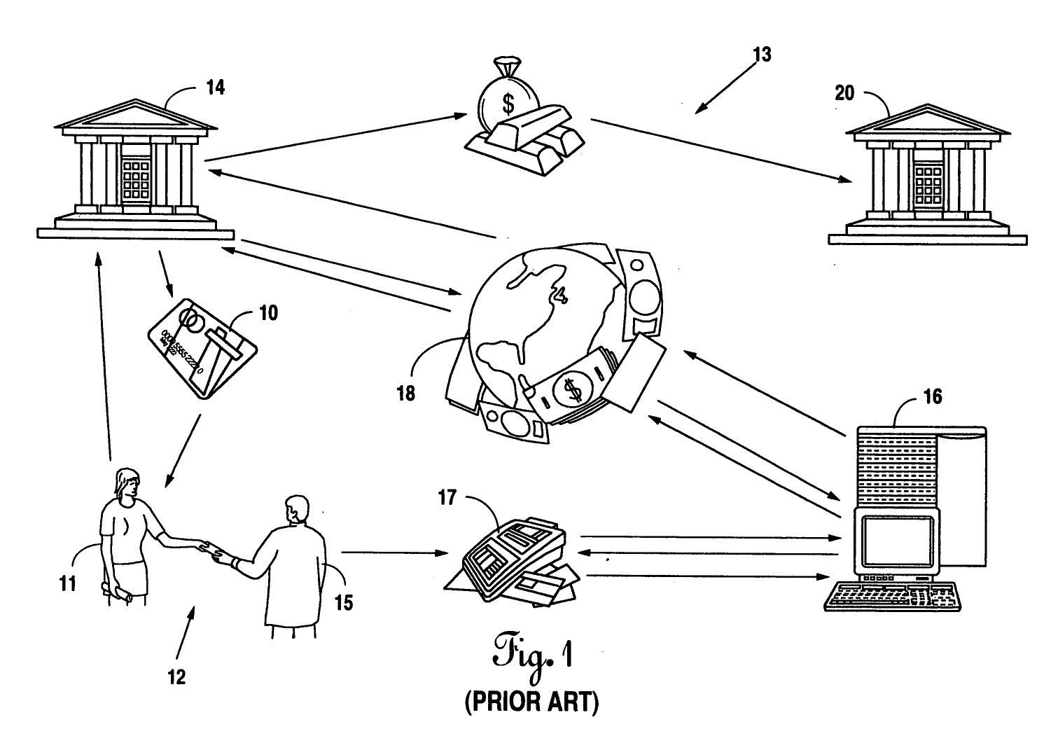

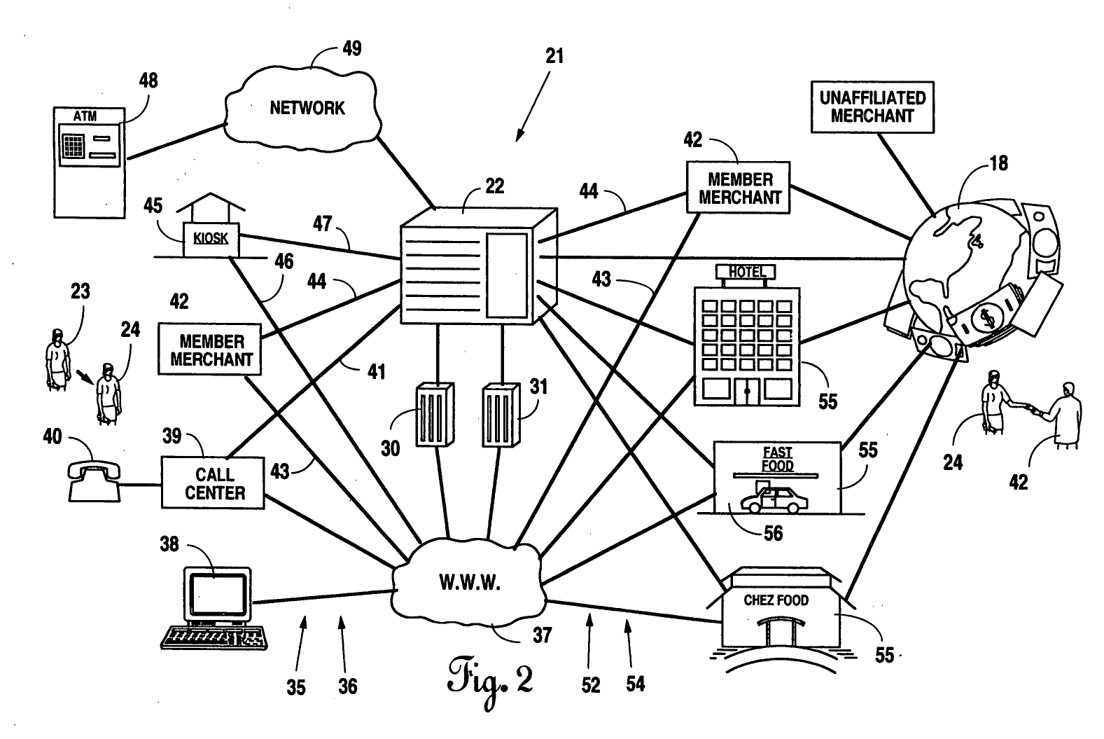

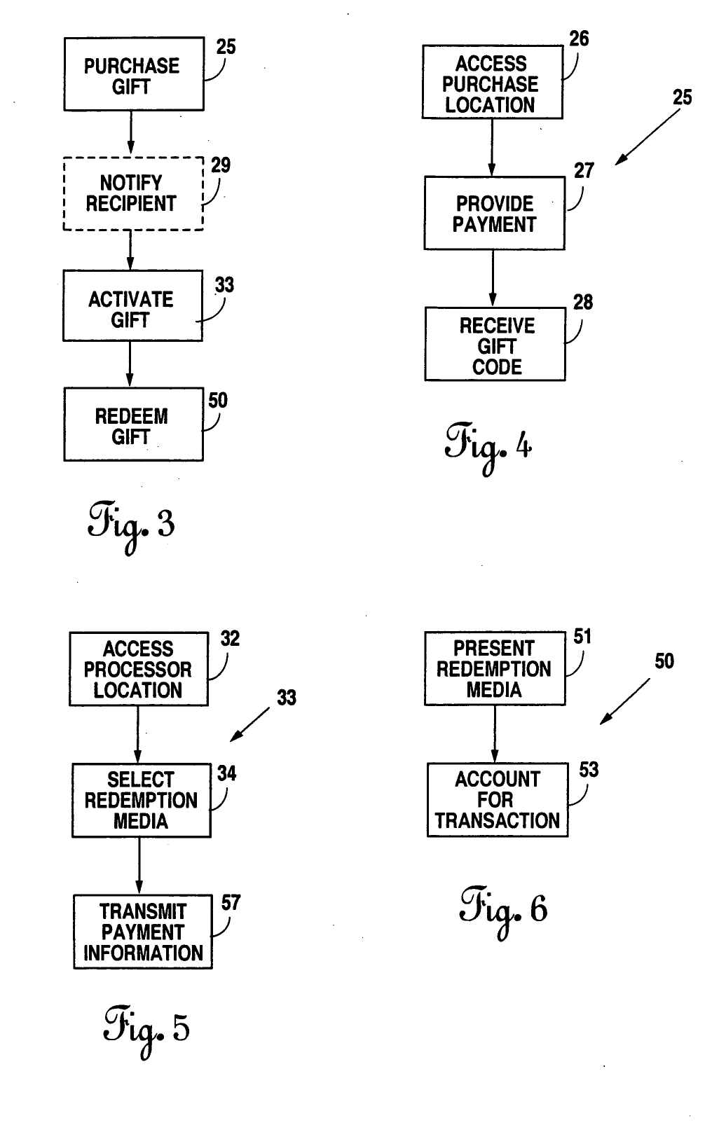

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

Referring now to FIG. 2, in particular, the preferred embodiment of the network topology 21 of the present invention, specifically adapted for efficient processing of consumer financial transactions, is shown to generally comprise an intermediary database server 22 adapted for storage and maintenance of financial and other information and various communications gateways 35, 36 to and/or from the intermediary database server 22 for the secure collection and selective conveyance of the financial and other information in facilitation of various consumer transactions. In primary use of the network topology 21 of the present invention, the database server 22 acts as an intermediary between a purchaser 23 of a financial benefit and a beneficiary 24 of the purchase. In particular, the intermediary database server 22 is adapted to securely collect financial account data from the purchaser 23 and, thereafter, to enable to beneficiary 24 to make use of the financial account data without the beneficiary 24 having actual access to the account data.

Additionally, as will be better understood further herein, the network topology 21 of the present invention contemplates the provision of the financial account data in any of a variety of media for utilization by the beneficiary 24 in any of a variety of media. For example, the financial account data may be provided by the purchaser in the form of a bank routing number and checking account number and utilized by the beneficiary in the form of a credit card number. Still further, the network topology 21 of the present invention also contemplates various efficiencies in the maintenance and conveyance of non-financial information in facilitation of otherwise consumer type transactions. This and other aspects of the present invention will be better understood further herein.

In the principle application of the network topology 21 of the present invention, it is contemplated that a purchaser 23 will gift a financial benefit to a beneficiary 24. In implementation of this aspect of the present invention, there is provided in association with the intermediary database server 22 at least one purchase gateway 36 for accessing (step 26) the intermediary database server 22 for the provision (step 27) by the purchaser 23, and, thus, collection by the intermediary database server 22, of financial account data belonging to the purchaser 23 (step 25). As will be better appreciated further herein, this financial account data may take any of a variety of forms including, for example: an account number of a deposit account maintained by the intermediary database server 22 for the use of the purchaser; a financial institution routing number and account number for a banking account, such as a checking or savings account, maintained by the purchaser 23 at the financial institution; credit card information, such as a credit card number and corresponding expiration date, for a universal or merchant credit card maintained by the purchaser 23; or any other appropriate form. Additionally, the provided and collected financial account data will also include a transaction amount, indicating the extent of the benefit to be gifted to the beneficiary 24, and the purchaser 23 may be given the option of restricting the manner of use by the beneficiary 24 of the gift.

In a further aspect of the present invention, it is also contemplated that the infrastructure provided in implementation of the principle application of the present invention may be utilized to streamline for the beneficiary 24 various consumer transactions although in this case the beneficiary 24 is not necessarily in receipt of a gift. To this end, as previously mentioned, the intermediary database server 22 is preferably adapted to collect and store “other information.” In particular, the intermediary database server 22 may be adapted for the collection and storage of personal information pertaining to the beneficiary 24, including, for example address information, telephone numbers, take out preferences, restaurant seating preferences, hotel rooming preferences, financial account information pertaining to the beneficiary, product purchase preferences and the like. In this manner, the various aforementioned consumer transactions may through utilization of the stored information be streamlined by substantially automating common purchases, as will be better understood further herein.

In any case, according to one implementation of the present invention, upon provision (step 27) of his or her financial account data the purchaser 23 receives (step 28) back through the purchase gateway 36 a unique code corresponding to and identifying the purchase transaction. In this implementation, the purchaser 23 conveys (step 29) the code to his or her chosen beneficiary 24 by any means. In a further implementation of the present invention, however, the intermediary database server 22 may be associated with a notification gateway for conveyance to said beneficiary of information indicating activity at said intermediary database server pertaining to said beneficiary. As will be appreciated by those of ordinary skill in the art, such a notification gateway may comprise an e-mail server 30, which may be utilized to perform the notification step on behalf of the purchaser 23 given that the beneficiary's e-mail address has be provided to the intermediary database server as “other information,” or an Internet web server 31, which may be accessed by the beneficiary, or the like. Additionally, it should be noted that there may be one person or entity as a sole beneficiary or there may be a number of persons or entities that share in the gift as beneficiaries 24or there may be a primary beneficiary who may designate others as beneficiaries 24or any such combination. In the case of multiple beneficiaries, the persons or entities may be entitled to receive all or a designated part of the gift or may utilize the gift jointly.

Regardless of manner of notification, once given the unique code corresponding to and identifying a financial benefit, the beneficiary 24 is then required to access (step 32) the intermediary database server 22 for activation (step 33) of the gift. In implementation of this aspect of the present invention, there is provided in association with the intermediary database server 22 at least one activation gateway 35 for accessing the intermediary database server 22 for provision by the beneficiary 24, and, thus, collection by the intermediary database server 22, of the unique code as well as identifying information for the beneficiary 24. Additionally, the beneficiary may be required to select a form for redemption (step 34) of the gifted financial benefit. As will be better understood further herein, the range of acceptable identifying information and the available choices for redemption of the gifted financial benefit will vary according to both the particular implementation of the present invention and whether restrictions on use of the benefit were placed by the purchaser 23.

In any case, as shown in FIG. 2, the activation gateway or gateways 35 may take generally the same form as the purchase gateway 36 or gateways and, in fact, may double one for another. In implementation of the present invention, any communication channel enabling the conveyance of the previously discussed information may be utilized for the purchase and activation gateways 36, 35. It is highly desirable, however, that the implemented channels be secure in nature in order to protect the sensitive financial and/or personal information that must be conveyed between the purchaser 23, beneficiary 24 and intermediary database server 22. Although those of ordinary skill in the art will in light of this exemplary description surely recognize other substantially equivalent implementations for the purchase and activation gateways 36, 35, Applicant has identified a number of particularly suitable possibilities. For example, the purchase and activation gateways 36, 35 may be readily implemented by providing a secure web server 31 in communication with the intermediary database server 22 and the Internet 37. Purchasers 23 and beneficiaries 24 alike may then access the (steps 26, 32) intermediary database server 22 by accessing through a personal computer 38 an associated website hosted on the web server 31.

For purchasers 23 or beneficiaries 24 without Internet access, however, a number of other options may be readily implemented. For example, the operator of the network topology 21 of the present invention may set up a telephone call center 39, which may be accessed by purchasers 23 or beneficiaries 24 through the telephone system 40. An operator, or, in the alternative, an automated attendant, at the call center 39 may then over the telephone 40 take the appropriate information from the purchaser 23 or beneficiary 24 and then, in turn, convey the information to the intermediary database server 22. As shown in the figure, the call center 39 may access the intermediary database server 22 through the Internet 37 or through a point-to-point electronic communication channel 41 or the like. Similarly, the purchaser 23 or beneficiary 24 may provide the necessary information to a clerk at a member merchant location 42. As will be better understood further herein, the member merchant 42 will have some form of electronic communication with the intermediary database server 22, such as an Internet connection 43 or point-to-point communication channel 44 or the like, for the later utilization by the beneficiary 24 of the gift. The same communication channel, however, may be utilized as either the purchase gateway 36 or the activation gateway 35. Still further, self-service kiosks 45 or the like may be positioned in locations likely frequented by purchasers 23 or beneficiaries 24, such as the common spaces of shopping malls. In one implementation of such a kiosk 45, the kiosk 45 may simply comprise a personal computer with Internet access 46 restricted to accessing the website associated with the intermediary database server 22. In the alternative, however, such a kiosk 45 may comprise a point-to-point electronic communication channel 47 or the like with the intermediary database server 22. Finally, those of ordinary skill in the art will recognize that automated teller machines 48, or other existing financial transaction systems, may be readily adapted for use with the network topology 21 of the present invention. In such an implementation, the purchaser 23 or beneficiary 24 simply utilizes the facilities of the automated teller machine 48 to communicate, through the banking network 49, with the intermediary database server 22. It should also be noted, however, that in the case of a merchant provided purchase gateway 43, 44, the purchaser 23 may purchase (step 25) a financial benefit with cash by tendering cash to the merchant 42, which in turn completes the purchase transaction on behalf of the purchaser 23 utilizing the merchant's interconnection 43, 44 with the intermediate database server 22.

As previously discussed, the purchaser 23 may, upon purchase (step 25) of the gift, be given the option of restricting the manner of use by the beneficiary 24 of the gift and, at activation (step 33) of the gift, the range of acceptable identifying information for the beneficiary and the available choices for redemption of the gifted financial benefit will vary according to both the particular implementation of the present invention and whether restrictions on use of the benefit were placed by the purchaser 23. For example, in one case the purchaser 23 may simply wish to make funds generally available for the use of the beneficiary 24. In this case, the purchaser conveys (step 27) his or her selected financial account data and a transaction amount without further restriction or specification regarding use of the benefit. In another case, however, the purchaser 23 may wish to restrict use of the benefit to purchases made from only certain merchants or for only certain products or services. In this case, the intermediary database server 22 is adapted to collect and process the purchaser's selections. Preferably, such selections are made by choosing one or more items from a predetermined list. For example, the purchaser 23 may be given the choice of allowing the gift to be utilized “IN ANY MANNER,” for purchases made from “MERCHANT X,” for purchases made for “FOOD PRODUCTS,” or the like. In the case of the purchaser allowing the gift to be utilized “IN ANY MANNER,” the range of acceptable identifying information for the beneficiary 24 and the available choices for redemption (step 50) of the gifted financial benefit will be limited only by the capabilities provided in the particular implementation of the network topology 21 of the present invention, as will be more apparent further herein. In the case of the purchaser 23 specifying, for example, that the gift may be utilized only for purchases made from “MERCHANT X” or only for purchases made for “FOOD PRODUCTS,” however, the range of acceptable identifying information for the beneficiary 24 and the available choices for redemption (step 50) of the gifted financial benefit will be limited for enforcement of the purchaser's restrictions.

Continuing with the example of the gift being restricted to being utilized only for purchases made from “MERCHANT X,” the range of identifying information may be accordingly limited to provision by the beneficiary 24 of card information, such as a card number, for a merchant credit card issued to the beneficiary by Merchant X and the choice for redemption (step 50) of the benefit then strictly limited to utilization by the beneficiary 24 of that merchant credit card. As will be better appreciated further herein, however, restriction of the gift to being utilized only for purchases made from a particular merchant, only for certain products or the like may be enforced through a wide range of techniques and will not generally require limitation of either the range of acceptable identifying information or the number of media choices for redemption (step 50) of the benefit, limitation being more a question of implementation complexity.

Although those of ordinary skill in the art will recognize in light of this exemplary disclosure that other substantially equivalent categories may be set forth, Applicant has found the following categories of identifying information for the beneficiary 24 particularly suited for implementation of the present invention: credit card information for a universal credit card 10 maintained by the beneficiary 24; card information for a merchant credit card issued by a merchant 42 and maintained by the beneficiary 24; an identification code from a gift card issued by a merchant 42 and maintained by the beneficiary 24; an identification code from an identification card issued to the beneficiary 24 by a governmental body; an identification code from an identification card issued to the beneficiary 24 by a private entity; an identification code for an incentive program operated by a merchant 42 and identifying the beneficiary 24 with the program; and an identification code for membership by the beneficiary 24 in a purchasing group affiliated with a merchant 42.

Likewise, Applicant has found the following categories of choice for manner of redemption (step 50) of the gift to be generally suitable for implementation of the present invention: utilization of a universal or merchant credit card maintained by the beneficiary 24 and utilization of a gift voucher honored by a merchant 42. As will be appreciated by those of ordinary skill in the art, utilization of the gift voucher may contemplate utilization of a gift card issued by the merchant 42 or deduction of credit from a gift account for the beneficiary 24 that is maintained by the merchant 42 through an electronic or other database entry. In any case, it should be recognized that in many cases the selection of either the manner of redemption (step 50) or choice of identifying information will dictate the other; for example, provision of a universal credit card number as the beneficiary's identifying information will generally dictate that the manner of redemption (step 50) be through use (step 51) of the universal credit card 10 bearing the provided credit card number. In other cases, however, the selection will be limited only upon particular implementation. For example, the beneficiary 24 may choose to redeem (step 50) his or her benefit by utilizing a gift account for the beneficiary 24 that is maintained by a particular merchant 42 for whom it is acceptable that the beneficiary 24 be identified in any of a number of manners such as, for example, by driver's license number, major credit card number, an identification code for membership by the beneficiary 24 in a purchasing group affiliated with a merchant 42, an identification code transmitted by a radio frequency identification (“RFID”) tag (such as are utilized for toll roads, parking garages and the like) or so forth.

Finally, the network topology 21 of the present invention comprises a payment gateway 52 for secure conveyance by the intermediary database server 22 to a third party of payment and/or other data. Through the payment gateway 52, a credit may be placed on the beneficiary's universal or merchant credit card account or in the “gift transaction” records of a merchant 42, depending upon the manner of activation (step 33) of the gift. For example, in the case where the financial benefit is provided by the purchaser 23 for use “IN ANY MANNER” by the beneficiary 24 and the beneficiary 24 chooses during activation (step 33) of the gift to redeem (step 50) the gift by use (step 51) of a universal credit card 10, the beneficiary 24 provides his or her credit card information (along with the provided unique code) through the activation gateway 35. The intermediary database server 22 then accesses the appropriate credit card association network 18 through the payment gateway 52 to electronically place a credit, using the securely stored financial information of the purchaser 23, on the beneficiary's credit card account (step 57). In the alternative, as appropriate for use with financial benefits purchased by provision of banking information or case, the intermediary database server may be utilized to make an electronic funds transfer to the beneficiary's credit card account (step 57). Likewise, should the beneficiary choose to redeem his or her gift through a gift card or the like, an electronic message may be communicated through the payment gateway 52 from the intermediary database server 22 to a database storing and/or managing a merchant's gift program (step 57). This function, of course, could also be handled under contract with the merchant 42 by the intermediary database server 22.

In any case, Applicant has found that the payment gateway 52 may be readily implemented by providing a communication channel between the intermediary database server 22 and a credit card association processing network 18, an electronic communication channel between the intermediary database server 22 and a merchant location 42 or the like. The appropriate implementation will depend only upon the features and capabilities for redemption desired in a particular embodiment of the present invention. As will be appreciated by those of ordinary skill in the art, the beneficiary 24 simply presents (step 51) the chosen redemption media at an appropriate merchant location 42 to utilize his or her gift. The merchant 42 then accounts (step 53) for the transaction as usual, taking into consideration the gift amount as transmitted through the payment gateway 52 from the intermediary database server 22.

As previously discussed, the network topology 21 of the present invention also preferably contemplates the collection and storage of non-financial information pertaining to the beneficiary 24. While those of ordinary skill in the art will recognize that such information may be transmitted through the payment gateway 52 to a particular merchant 42 in facilitation of a consumer transaction, such as the placing of a takeout order or making of a hotel or restaurant reservation, the network topology 21 of the present invention may additionally be provided with a hospitality gateway 54 specifically for conveying such information to the provider of a product or the provider 55 of a service such as, for example, take out services, restaurant services, hotel services or the like. In application, the beneficiary 24 may simply access the intermediary database server 22 through an activation gateway 35 and indicate, for example, that he or she wishes to place a takeout order from a previously associated restaurant 56. The order information, which may be entirely based upon pre-selected food and beverage preferences, and, if desired, payment information may then be transmitted directly from the intermediary database server 22 to the appropriate merchant location through either a payment or hospitality gateway 52, 54. The beneficiary 24 need then only present proper identification at the time of pickup of the order, which of course will be ready at a designated time.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, the intermediary database server 22 may be further adapted for the collection and storage of information pertaining to product promotions such as, for example, information indicating a product discount (essentially an electronic coupon) or an available rebate. In such an embodiment, the beneficiary 24 may utilize an activation gateway 35 to determine what promotions may be available to him or her. Of particular utility, the intermediate database server 22 may be adapted to provide this promotion information based upon the preference information pertaining to the beneficiary 24 and collected and stored by the intermediary database server 22. Further, the intermediary database server 22 may make this type of promotional information available based upon other collected data, such as the location of the beneficiary 24 as gleaned from a hotel reservation made through a hospitality gateway 54. In any case, because the scope of the present invention is much broader than any particular embodiment, the foregoing detailed description should not be construed as a limitation of the scope of the present invention, which is limited only by the claims appended hereto.

1. A network topology for efficient processing of consumer financial transactions, said network topology comprising:
an intermediary database server adapted for the secure collection and selective conveyance of financial information in facilitation of consumer financial transactions, wherein:
said financial information comprises a credit purchaser's financial account data and a transaction amount; and
said intermediary database server is programmed to provide the purchaser with a unique code upon provision by the purchaser of the purchaser's financial account data and transaction amount;
a purchase gateway for accessing said intermediary database server for the provision by the purchaser, and collection by the intermediary database server, of the purchaser's financial account data;
an activation gateway for the subsequent secure collection of said unique code and a beneficiary's identifying information and redemption selection, wherein:
said identifying information takes the form of one of a predetermined set of media; and
said redemption selection is chosen from a predetermined set of choices; and
a payment gateway for secure conveyance by said intermediary database server to a third party of payment data, said third party being determined according to the beneficiary's identifying information and redemption selection.

2. The network topology as recited in claim 1, wherein said credit purchaser's financial account data comprises an account number of a deposit account maintained by said intermediary database server for the benefit of said credit purchaser.

3. The network topology as recited in claim 2, wherein said purchase gateway comprises an Internet web server.

4. The network topology as recited in claim 2, wherein said purchase gateway comprises a payment kiosk, said payment kiosk providing electronic communication with said intermediary database server.

5. The network topology as recited in claim 2, wherein said purchase gateway comprises a merchant location, said merchant location having an electronic communication channel with said intermediary database server.

6. The network topology as recited in claim 1, wherein said credit purchaser's financial account data comprises a financial institution routing number and account number for a banking account maintained by said credit purchaser at the financial institution.

7. The network topology as recited in claim 6, wherein said credit purchaser's financial account data comprises a financial institution routing number and account number for a savings account maintained by said credit purchaser at the financial institution.

8. The network topology as recited in claim 6, wherein said credit purchaser's financial account data comprises a financial institution routing number and account number for a checking account maintained by said credit purchaser at the financial institution.

9. The network topology as recited in claim 6, wherein said purchase gateway comprises an Internet web server.

10. The network topology as recited in claim 6, wherein said purchase gateway comprises a payment kiosk, said payment kiosk providing electronic communication with said intermediary database server.

11. The network topology as recited in claim 6, wherein said purchase gateway comprises a merchant location, said merchant location having an electronic communication channel with said intermediary database server.

12. The network topology as recited in claim 6, wherein said purchase gateway comprises an automated teller machine.

13. The network topology as recited in claim 1, wherein said purchase gateway comprises an Internet web server.

14. The network topology as recited in claim 1, wherein said purchase gateway comprises a payment kiosk, said payment kiosk providing electronic communication with said intermediary database server.

15. The network topology as recited in claim 1, wherein said purchase gateway comprises a merchant location, said merchant location having an electronic communication channel with said intermediary database server.

16. The network topology as recited in claim 1, wherein said purchase gateway comprises an automated teller machine.

17. The network topology as recited in claim 1, wherein said credit purchaser's financial account data comprises credit card information for a credit card maintained by said credit purchaser.

18. The network topology as recited in claim 17, wherein said purchase gateway comprises an Internet web server.

19. The network topology as recited in claim 17, wherein said purchase gateway comprises a payment kiosk, said payment kiosk providing electronic communication with said intermediary database server.

20. The network topology as recited in claim 17, wherein said purchase gateway comprises a merchant location, said merchant location having an electronic communication channel with said intermediary database server.

21. The network topology as recited in claim 17, wherein said purchase gateway comprises an automated teller machine.

22. The network topology as recited in claim 17, wherein:
said identifying information comprises credit card information for a credit card maintained by said beneficiary; and
said redemption selection comprises utilization of said credit card maintained by said beneficiary.

23. The network topology as recited in claim 22, wherein said purchase gateway comprises an Internet web server.

24. The network topology as recited in claim 22, wherein said purchase gateway comprises a payment kiosk, said payment kiosk providing electronic communication with said intermediary database server.

25. The network topology as recited in claim 22, wherein said purchase gateway comprises a merchant location, said merchant location having an electronic communication channel with said intermediary database server.

26. The network topology as recited in claim 22, wherein said purchase gateway comprises an automated teller machine.

27. The network topology as recited in claim 22, wherein said payment gateway comprises a communication channel between said intermediary database server and a credit card association processing network.

28. The network topology as recited in claim 27, wherein said purchase gateway comprises an Internet web server.

29. The network topology as recited in claim 27, wherein said purchase gateway comprises a payment kiosk, said payment kiosk providing electronic communication with said intermediary database server.

30. The network topology as recited in claim 27, wherein said purchase gateway comprises a merchant location, said merchant location having an electronic communication channel with said intermediary database server.

31. The network topology as recited in claim 27, wherein said purchase gateway comprises an automated teller machine.

32. The network topology as recited in claim 22, wherein said payment gateway comprises an electronic communication channel between said intermediary database server and a merchant location.

33. The network topology as recited in claim 32, wherein said purchase gateway comprises an Internet web server.

34. The network topology as recited in claim 32, wherein said purchase gateway comprises a payment kiosk, said payment kiosk providing electronic communication with said intermediary database server.

35. The network topology as recited in claim 32, wherein said purchase gateway comprises a merchant location, said merchant location having an electronic communication channel with said intermediary database server.

36. The network topology as recited in claim 32, wherein said purchase gateway comprises an automated teller machine.

37. The network topology as recited in claim 17, wherein said redemption selection comprises utilization of a gift voucher honored by a merchant.

38. The network topology as recited in claim 37, wherein said identifying information comprises card information for a merchant credit card issued by said merchant.

39. The network topology as recited in claim 38, wherein said purchase gateway comprises an Internet web server.

40. The network topology as recited in claim 39, wherein said payment gateway comprises an electronic communication channel between said intermediary database server and a merchant location.

41. The network topology as recited in claim 38, wherein said purchase gateway comprises a payment kiosk, said payment kiosk providing electronic communication with said intermediary database server.

42. The network topology as recited in claim 41, wherein said payment gateway comprises an electronic communication channel between said intermediary database server and a merchant location.

43. The network topology as recited in claim 38, wherein said purchase gateway comprises a merchant location, said merchant location having an electronic communication channel with said intermediary database server.

44. The network topology as recited in claim 43, wherein said payment gateway comprises an electronic communication channel between said intermediary database server and a merchant location.

45. The network topology as recited in claim 38, wherein said purchase gateway comprises an automated teller machine.

46. The network topology as recited in claim 45, wherein said payment gateway comprises an electronic communication channel between said intermediary database server and a merchant location.

47. The network topology as recited in claim 37, wherein said identifying information comprises an identification number from a gift card issued by said merchant.

48. The network topology as recited in claim 47, wherein said purchase gateway comprises an Internet web server.

49. The network topology as recited in claim 48, wherein said payment gateway comprises an electronic communication channel between said intermediary database server and a merchant location.

50. The network topology as recited in claim 47, wherein said purchase gateway comprises a payment kiosk, said payment kiosk providing electronic communication with said intermediary database server.

51. The network topology as recited in claim 50, wherein said payment gateway comprises an electronic communication channel between said intermediary database server and a merchant location.

52. The network topology as recited in claim 47, wherein said purchase gateway comprises a merchant location, said merchant location having an electronic communication channel with said intermediary database server.

53. The network topology as recited in claim 52, wherein said payment gateway comprises an electronic communication channel between said intermediary database server and a merchant location.

54. The network topology as recited in claim 47, wherein said purchase gateway comprises an automated teller machine.

55. The network topology as recited in claim 54, wherein said payment gateway comprises an electronic communication channel between said intermediary database server and a merchant location.

56. The network topology as recited in claim 37, wherein said identifying information comprises an identification number from an identification card issued by a governmental body.

57. The network topology as recited in claim 56, wherein said purchase gateway comprises an Internet web server.

58. The network topology as recited in claim 57, wherein said payment gateway comprises an electronic communication channel between said intermediary database server and a merchant location.

59. The network topology as recited in claim 56, wherein said purchase gateway comprises a payment kiosk, said payment kiosk providing electronic communication with said intermediary database server.

60. The network topology as recited in claim 59, wherein said payment gateway comprises an electronic communication channel between said intermediary database server and a merchant location.

61. The network topology as recited in claim 56, wherein said purchase gateway comprises a merchant location, said merchant location having an electronic communication channel with said intermediary database server.

62. The network topology as recited in claim 61, wherein said payment gateway comprises an electronic communication channel between said intermediary database server and a merchant location.

63. The network topology as recited in claim 56, wherein said purchase gateway comprises an automated teller machine.

64. The network topology as recited in claim 63, wherein said payment gateway comprises an electronic communication channel between said intermediary database server and a merchant location.

65. The network topology as recited in claim 37, wherein said identifying information comprises an identification number from an identification card issued by a private entity.

66. The network topology as recited in claim 65, wherein said purchase gateway comprises an Internet web server.

67. The network topology as recited in claim 66, wherein said payment gateway comprises an electronic communication channel between said intermediary database server and a merchant location.

68. The network topology as recited in claim 65, wherein said purchase gateway comprises a payment kiosk, said payment kiosk providing electronic communication with said intermediary database server.

69. The network topology as recited in claim 68, wherein said payment gateway comprises an electronic communication channel between said intermediary database server and a merchant location.

70. The network topology as recited in claim 65, wherein said purchase gateway comprises a merchant location, said merchant location having an electronic communication channel with said intermediary database server.

71. The network topology as recited in claim 70, wherein said payment gateway comprises an electronic communication channel between said intermediary database server and a merchant location.

72. The network topology as recited in claim 65, wherein said purchase gateway comprises an automated teller machine.

73. The network topology as recited in claim 72, wherein said payment gateway comprises an electronic communication channel between said intermediary database server and a merchant location.

74. The network topology as recited in claim 17, wherein said intermediary database server is further adapted for the collection and storage of personal information pertaining to said beneficiary.

75. The network topology as recited in claim 74, wherein said personal information comprises an address.

76. The network topology as recited in claim 74, wherein said personal information comprises a telephone number.

77. The network topology as recited in claim 1, wherein said intermediary database server is further adapted for the collection and storage of personal information pertaining to said beneficiary.

78. The network topology as recited in claim 77, wherein said personal information comprises an address.

79. The network topology as recited in claim 77, wherein said personal information comprises a telephone number.

80. The network topology as recited in claim 77, said network topology further comprising a hospitality gateway for conveyance of said personal information to a provider of a service.

81. The network topology as recited in claim 80, wherein said service comprises the provision of take out services.

82. The network topology as recited in claim 81, wherein said personal information comprises take out preferences.

83. The network topology as recited in claim 80, wherein said service comprises the provision of restaurant services.

84. The network topology as recited in claim 83, wherein said personal information comprises restaurant seating preferences.

85. The network topology as recited in claim 80, wherein said service comprises hotel services.

86. The network topology as recited in claim 85, wherein said personal information comprises rooming preferences.

87. The network topology as recited in claim 80, wherein said personal information comprises said beneficiary's financial account data.

88. The network topology as recited in claim 87, wherein said service comprises the provision of take out services.

89. The network topology as recited in claim 88, wherein said personal information further comprises take out preferences.

90. The network topology as recited in claim 87, wherein said service comprises the provision of restaurant services.

91. The network topology as recited in claim 90, wherein said personal information further comprises restaurant seating preferences.

92. The network topology as recited in claim 87, wherein said service comprises hotel services.

93. The network topology as recited in claim 92, wherein said personal further information comprises rooming preferences.

94. The network topology as recited in claim 1, wherein said intermediary database server is further is further adapted for the dissemination to said beneficiary of information pertaining to product promotions.

95. The network topology as recited in claim 94, wherein said information pertaining to product promotions comprises information indicating an available product discount.

96. The network topology as recited in claim 94, wherein said information pertaining to product promotions comprises information indication an available purchase price rebate.
